(19) United States
(12) Patent Application Publication
(10) Pub. No.: US 2010/0270221 A1
(43) Pub. Date: Oct. 28, 2010

(54) PORTABLE POLYMER HYDRATION - CONDITIONING SYSTEM

(75) Inventor: David B. REARDON, Houston, TX (US)

Correspondence Address: CONLEY ROSE, P.C.;David A. Rose, P. O. BOX 3267, HOUSTON, TX, 77253-3267, US

(73) Assignee: KEM-TRON TECHNOLOGIES, INC., Stafford, TX (US)

(21) Appl. No.: 12/431,494

(22) Filed: Apr. 28, 2009

(51) Int. Cl. B01D 21/01; C09K 8/24

(52) U.S. Cl. 210/178; 422/286; 507/117

(57) ABSTRACT

A portable polymer hydration-conditioning or make-down system for conditioning a neat polymer with water is disclosed. In some embodiments, the system includes a moveable housing supported by a plurality of wheels, a pump operable to pressurize the water, and an immersion heater operable to heat the water. The pump and immersion heater are disposed within the moveable housing.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The present disclosure relates generally to systems for de-watering drilling fluid. More particularly, the present disclosure relates to a portable system for conditioning polymers for use in de-watering waste drilling fluid.

A key element of any drilling process is the use of drilling fluid, or mud. The drilling fluid serves several purposes. The density, or weight, of the drilling fluid prevents formation fluids and gases from entering the wellbore, and thus controls formation pressures. The drilling fluid also suspends and carries drilled cuttings from the bottom of the wellbore to the surface. Solids control equipment at the surface enable the drilling fluid to recirculated continuously.

In order to provide bit lubrication and cooling, cuttings removal and well control, the properties of drilling fluid must be carefully controlled. As cuttings build up in drilling fluid, the weight and viscosity of the drilling fluid increases, which, in turn, increases drag forces on the drill bit slowing the rate of penetration (ROP), increases the thickness of wall cake on the borehole wall, and makes control of the well pressure more difficult. To control the drilling fluid weight and viscosity, and thus prevent loss of well control, reduced ROP, and/or a drilling component from becoming stuck in the borehole due to increased wall cake thickness, water is added to the reclaimed drilling fluid to condition it prior to re-injection.

De-watering systems enable water to be reclaimed from waste drilling fluid and subsequently combined with unused or recirculated drilling fluid being pumped down the drill pipe and returned to the surface. Using reclaimed water to maintain volume and conditioning of the drilling fluid prior to being recirculated down hole enables reduces the costs associated with transporting clean water to the well site for such purposes. After water is separated from waste drilling fluid, the remaining solid waste is smaller in volume and lighter in weight, as compared to that of the waste drilling fluid prior to de-watering, and can be transported from the well site and disposed of at significantly less expense.

Conventional de-watering systems deliver waste drilling fluid through a linear motion shaker, a de-sander and de-silter hydrocyclone, and a decanter centrifugre. The waste drilling fluid initially passes through the linear motion shaker, which is capable of handling 100% of the mud pump flow while removing coarse sized solid particles between 320 to 75 microns, depending upon the screen mesh size being used. The drilling fluid then passes through the de-sander and de-silter hydrocyclone for further removal of fine and silt sized drill solid particles, ranging in size between 20 to 74 micron, at a process rate of approximately 110% of the mud pump flow rate. Finally, the fluids are processed by a high speed solids control decanter centrifuge to remove ultra-fine drill solid particles greater than 5 micron at an average process rate of approximately 20% of the mud pump flow rate.

Studies have shown that the lower the colloidal content in a water-based drilling fluid, for example, fluids having particulates having sizes less than 2 microns, the faster the drill bit rate of penetration (ROP). Minimizing colloidal solids lowers the plastic viscosity of drilling fluid, contributing to greater horsepower at the bit. However, removing colloidal solids becomes difficult if not impossible, if they are allowed to accumulate and further degrade when continuously recirculated in the drilling fluid. Colloidal solids may be removed from the drilling fluid waste by particle charge destabilization with a high cationic charged/low molecular weight polymer and aggregated together to form a “Hard Floc” with the addition of a varying anionic charged/high molecular weight polymer.

To increase the overall efficiency of conventional de-watering systems, polyelectrolytes or polymers are often added to the drilling fluid prior to entering the centrifuge. Drilling fluid is a suspension of various sized solids generated from the ground or commercially produced, and water. The solid particles carry an electrical charge that causes them to repel one another, thereby enabling the solids to be suspended in the water. Due to these repulsive forces and the concentration of colloidal/ultra-fine solids, the drilling fluid would require such a significant amount of time as to make this natural process an impractical means of de-watering. To accelerate the de-watering process, the drilling fluid is first treated with a coagulant to de-stabilize the suspended solids of the mixture. As used herein, de-stabilization refers to the process of neutralizing the electrical charge of solids suspended in the colloidal mixture, or drilling fluid, so as to reduce or breakdown their repulsive forces.

After de-stabilization of the solids, a flocculant is added to the drilling fluid to aggregate the de-stabilized solids so that when the drilling fluid passes through the centrifuge, the de-stabilized and subsequently aggregated solids do not break apart and cause the centrate, or reclaimed water, to become highly turbid and discharge wet cake solids. The flocculant has an electrical charge that attracts the de-stabilized solids, causing the solids to attach themselves to the flocculant. Attachment of the de-stabilized solids to the flocculant forms an aggregated network of de-stabilized solids called flocs. By de-stabilizing and subsequently aggregating the solids into flocs, the solids and water of the colloidal mixture, or drilling fluid, may be more easily and effectively separated in the centrifuge, thereby increasing the overall efficiency of the de-watering process.

Prior to adding the coagulant and flocculant to the drilling fluid, each polymer must be conditioned, a process commonly referred to as “make-down.” Conditioning each polymer involves mixing water into, or hydrating, a concentrated, or neat, form of the polymer and then allowing sufficient residence time for the hydrated polymer to uncoil or branch out in response to exposure to water. Improper make-down of the polymers results in reduced de-watering efficiency and waste of the neat polymer materials. In worst case, an improperly conditioned coagulant fails to de-stabilize solids in the drilling fluid. Similarly, an improperly conditioned flocculant fails to aggregate the de-stabilized solids. Either way, the de-watering process fails to reclaim water disposed within the waste drilling fluid.

Polymers typically used in de-watering waste drilling fluid have long, fragile chains and are sensitive to high mechanical shear forces and temperature. Adequate water pressure without mechanical shear and temperature improves mixing, or hydration, of the polymers and reduces the time required for hydration. The pressure and temperature of water used for make-down of polymers in conventional de-watering systems are often limited by the source of that water.

For instance, gravity-fed water may be provided from a storage tank to make-down the polymers. In such cases, the water pressure is too low for proper make-down, leading to reduced de-watering efficiency and waste of the neat polymer materials. To increase the water pressure, the water may be passed through a centrifugal pump and then delivered from the pump by hose for make-down. Due to pressure loss within the hose, the pressure of water delivered may still be too low for proper make-down.

Moreover, the water source is exposed to environmental conditions. During winter or at well sites located in cold environments, the water temperature is often too low. Consequently, the polymers will not go into solution quickly during make-down. As in the case of improper water pressure, water temperatures that are too low result in decreased de-watering efficiency and increased mixing or hydration time.

Embodiments of the present disclosure are directed to systems and methods that seek to overcome these and other limitations of the prior art.

### SUMMARY OF SOME OF THE PREFERRED EMBODIMENTS

A portable polymer hydration-conditioning system for use in de-watering waste drilling fluid is disclosed. In some embodiments, the portable polymer hydration-conditioning system includes a moveable housing supported by a plurality of wheels, a pump operable to pressurize water for conditioning a neat polymer, and an immersion heater operable to heat the water. The pump and immersion heater are disposed within the moveable housing.

Some systems for de-watering waste drilling fluid include a moveable housing supported on wheels and a conditioning manifold in fluid communication with the moveable housing. The moveable housing includes a water pump operable to pressurize water, a heater operable to heat the water, and a static mixer configured to hydrate a neat polymer with the pressurized, heated water to yield a conditioned polymer. The conditioning manifold includes at least one of a de-stabilizing zone and an aggregating zone. The de-stabilizing zone is adapted to combine the conditioned polymer and the waste fluid, wherein solids suspended in the waste fluid are de-stabilized, wherein a de-stabilized mixture is formed. The aggregating zone is adapted to combine the conditioned polymer and a de-stabilized mixture including the waste fluid and de-stabilized solid particles, wherein de-stabilized solids contained in the de-stabilized mixture are aggregated to form a plurality of flocs, wherein an aggregated mixture of the plurality of flocs and water is formed.

Some methods for conditioning a neat polymer at a de-watering site include coupling a water source at the de-watering site to a water pump disposed within a moveable housing, coupling a container wherein the neat polymer is stored to a polymer pump disposed within the moveable housing, pressurizing water from the water source with the water pump, heating water from the water source with the immersion heater, and hydrating the neat polymer with the heated, pressurized water from the water source in a static mixer disposed within the moveable housing.

Thus, embodiments described herein comprise a combination of features and advantages intended to address various shortcomings associated with certain prior systems and methods. The various characteristics described above, as well as other features, will be readily apparent to those skilled in the art upon reading the following detailed description of the preferred embodiment, and by referring to the accompanying drawings.

### BRIEF DESCRIPTION OF THE DRAWINGS

For a more detailed understanding of the preferred embodiments, reference is made to the accompanying Figures, wherein:

FIG. 1 is a schematic representation of a de-watering system in accordance with the principles disclosed herein;

FIG. 2 is a schematic representation of the de-stabilizing and flocculating manifold of FIG. 1;

FIG. 3 is a schematic representation of the portable polymer hydration-conditioning system of FIG. 1;

FIG. 4 is a perspective view of an embodiment of the portable polymer hydration-conditioning system schematically illustrated by FIG. 3;

FIG. 5 is a perspective view of the portable polymer hydration-conditioning system of FIG. 4 without its doors and external panels, illustrating the equipment disposed therein;

FIG. 6 is a front view of the portably polymer hydration-conditioning system of FIG. 5; and

FIG. 7 is a side view of the portable polymer hydration-conditioning system of FIG. 5.

### NOTATION AND NOMENCLATURE

Certain terms are used throughout the following description and claims to refer to particular system components. This document does not intend to distinguish between components that differ in name but not function. Moreover, the drawing figures are not necessarily to scale. Certain features of the invention may be shown exaggerated in scale or in somewhat schematic form, and some details of conventional elements may not be shown in the interest of clarity and conciseness.

In the following discussion and in the claims, the term “comprises” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION OF THE PREFERRED EMBODIMENTS

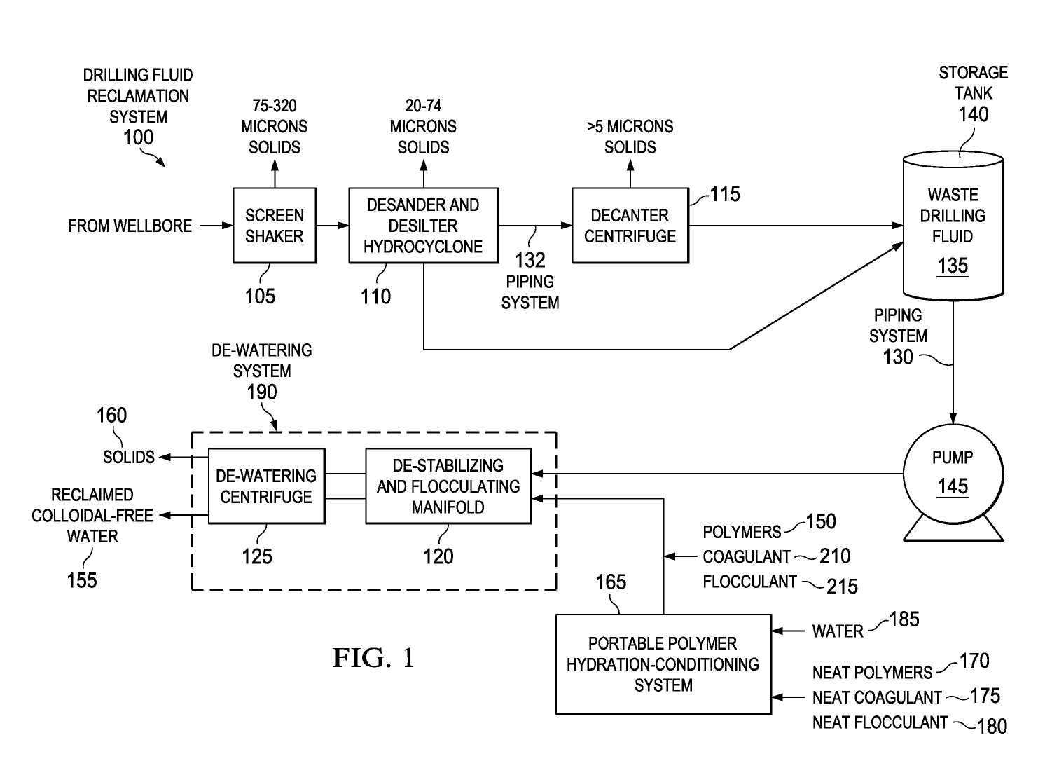

Referring now to FIG. 1, a schematic representation of a drilling fluid reclamation system, a de-watering system, and a portable polymer hydration-conditioning system in accordance with the principles disclosed herein are shown. As will be described, embodiments of a portable polymer hydration-conditioning are configured to enable make-down of one or more concentrated polymers with water to yield conditioning polymers for use in de-watering waste drilling fluid at a variety of de-watering sites, some of which may be located in cold environments and/or having inadequate water pressure or temperature. To enable polymer make-down in cold environments or at sites having inadequate water pressure and/or temperature, the portable polymer hydration-conditioning include a pump and a heater for conditioning the water prior to polymer make-down.

Drilling fluid reclamation system 100 includes a screen shaker 105, a desander and desilter hydrocyclone 110, and a decanter centrifuge 115 coupled by a piping system 132. Waste drilling fluid 135 reclaimed from a well bore at a well site is conveyed through piping system 132 to screen shaker 105 and the components of reclamation system 100 downstream of screen shaker 105. Upon exiting reclamation system 100, waste drilling fluid 135 is stored in a waste drilling fluid storage tank 140. In some embodiments of reclamation system 100, excess drilling fluid may also be conveyed to and stored in tank 140.

Each of screen shaker 105, hydrocyclone 110, and decanter centrifuge 115 are configured to remove progressively smaller solid particles from waste drilling fluid 135 as waste drilling fluid 135 passes therethrough. In this exemplary embodiment, screen shaker 105 removes solids having dimensions in the range 75 to 320 microns. Hydrocyclone 110 removes relatively smaller solids having dimensions in the range 20 to 74 microns. Decanter centrifuge 115 removes particulates having dimensions greater than 5 microns. Thus, as waste drilling fluid 135 passes through each of these respective devices 105, 110, 115, more solids are progressively removed from waste drilling fluid 135, thereby decreasing the concentration of solids suspended in drilling fluid 135.

De-watering system 190 includes a de-stabilizing and flocculating conditioning manifold 120 and a de-watering centrifuge 125, both connected in series by a piping system 130. Reclaimed waste drilling fluid 135, contained in a storage tank 140, is delivered by a pump 145 through piping system 130 to manifold 120 and de-watering centrifuge 125. In this exemplary embodiment, pump 145 is a progressive cavity feed pump. However, in other embodiments, pump 145 may be another type of pump known in the industry.

De-watering centrifuge 125 applies centrifugal force to waste fluid drilling 135 passing therethrough. The centrifugal force creates a pressure load exerted on waste drilling fluid 135, causing water contained therein to be forced from waste solids also contained in drilling fluid 135. In some embodiments, de-watering centrifuge 125 removes particulates having dimensions less than 5 microns when de-watering chemicals are applied.

To promote the ease and effectiveness at which high-speed de-watering centrifuge 125 removes particulates from waste drilling fluid 135 passing therethrough, waste drilling fluid 135 is treated or conditioned within coagulation and flocculation manifold 120 with hydrated polymers 150 prior to entering de-watering centrifuge 125. Conditioning polymers 150 includes a coagulant 210 and a flocculant 215.

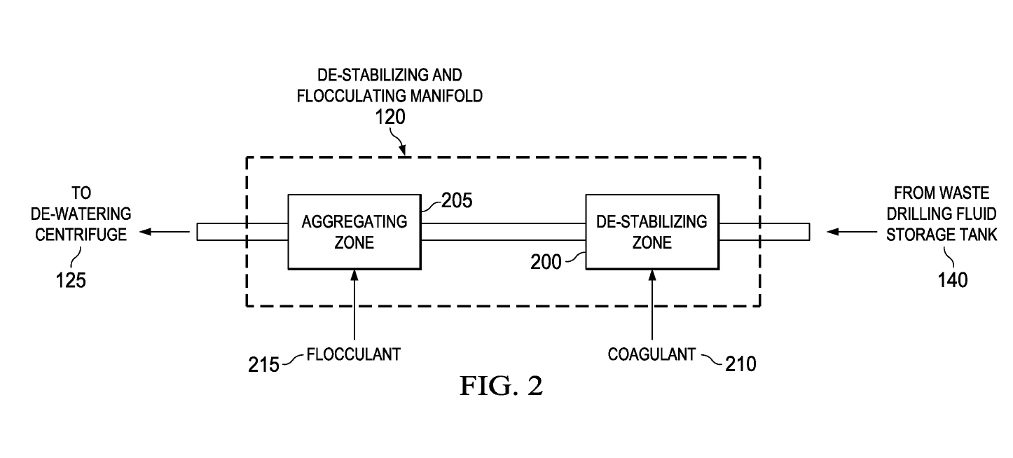

Turning now to FIG. 2, conditioning manifold 120 includes a de-stabilizing zone 200 and an aggregating zone 205. Waste drilling fluid 135 is conveyed via pump 145 from drilling waste storage tank 140 first into de-stabilizing zone 200 of manifold 120. Within de-stabilizing zone 200, conditioning coagulant 210 is introduced to waste drilling fluid 135 to de-stabilize solids remaining suspended in waste drilling fluid 135 and to subsequently form bridges between the de-stabilized solids to form a colloidal web. The colloidal web is an essential building block for developing a hard floc that maintains retention, i.e., does not break apart, regardless of shear stress and shear rate experienced when passing through manifold 120 and de-watering centrifuge 125.

Coagulant 210 has an electrical charge that acts to neutralize the electrical charge of solids suspended in drilling fluid 135 and a low molecular weight. Coagulant 210 may be organic or inorganic in nature. In preferred embodiments, coagulant 210 is organic and cationic, and has a molecular weight in the range 1000 to 1 million. The positive charge of coagulant 210 neutralizes the electrical charge of solids suspended in drilling fluid 135, and thus reduces or breaks down their repulsive forces relative to each other. In other words, coagulant 210 de-stabilizes the solids in drilling fluid 135. The low molecular weight of coagulant 210 enables faster de-stabilization of the solids and a lower viscosity of the water remaining in waste drilling fluid 135, as compared to that provided by the conventional use of inorganic coagulants.

After the solids remaining in waste drilling fluid 135 are de-stabilized, drilling fluid 135 passes from de-stabilizing zone 200 into aggregating zone 205 of manifold 120. Within aggregating zone 205, conditioning flocculant 215 is introduced to waste drilling fluid 135 to aggregate the de-stabilized solids contained therein to form a plurality of large, rounded flocs. Aggregating the de-stabilized solids enables the solids to withstand shear forces imparted to them during processing in high-speed centrifuge 125 without breaking the solids apart and causing the solids to become again dispersed or suspended in the water of waste drilling fluid 135.

Flocculant 215 has an electrical charge that attracts the de-stabilized solids within drilling fluid 135 and a high molecular weight. The electrical charge of organic flocculant 215 causes the de-stabilized solids to attach themselves to flocculant 215, thereby creating large floes of aggregated de-stabilized solids. The high molecular weight of flocculant 215 allows the large, rounded floes of de-stabilized solids to withstand shear forces imparted to the floes during processing by high-speed centrifuge 125. In some embodiments, flocculant 215 has a molecular weight in the range 13 million to 15 million.

Further, flocculant 215 may be organic or inorganic in nature, but is preferably organic. In preferred embodiments, the organic nature of flocculant 215 enables larger, harder and more rounded floes of de-stabilized solids, as compared to smaller, rougher floes achievable with the use of conventional inorganic flocculants. By increasing the floc size, the floes are more resistive to shear forces and thus less likely to break apart in high-speed centrifuge 125. As such, there is less of a need to slow the speed of centrifuge 125 to ensure the floes remain intact during processing in centrifuge 125. Also, the rounded configuration of the floes promote re-aggregation of the solids should some of them break apart in centrifuge 125. Thus, the larger, more rounded floes promote the overall efficiency and production rate of de-watering system 190.

After aggregation of the de-stabilized solids remaining in waste drilling fluid 135, drilling fluid 135 passes from aggregating zone 205 into de-watering centrifuge 125, where, as described above and illustrated in FIG. 1, the water remaining in drilling fluid 135 is forced from the floes of de-stabilized solids in drilling fluid 135 under pressure from centrifugal force applied to drilling fluid 135. Upon completion of processing in high-speed centrifuge 125, two products exit centrifuge 125: a colloidal-free or clear water 155, which may be re-used, for example, to maintain volume and properties of a drilling fluid prior to circulation downhole, and excavated cuttings or solids 160, which may be transported from the well site for disposal.

Referring briefly again to FIG. 1, conditioning polymers 150 are delivered from portable polymer hydration-conditioning system 165 to de-watering system 190. Portable polymer hydration-conditioning system 165 makes down concentrated, or neat, forms of polymers 150, identified as neat polymers 170, to yield conditioning polymers 150, such that conditioning polymers 150 provide optimum de-watering efficiency within de-watering system 190 with minimal waste of polymer materials. Make-down of neat polymers 170 includes dissolving neat polymers 170 with water 185, or hydrating polymers 170, and subsequently enabling sufficient residence time for the hydrated polymers or polymer working solutions to uncoil or branch out, or become uniform, thereby yielding conditioning polymers 150.

In this embodiment, neat polymers 170 includes a neat coagulant 175 and a neat flocculant 180. Neat coagulant 175 and neat flocculant 180 may each be in emulsion or liquid form. In some embodiments, neat coagulant 175 is a polyamine coagulant, such as COLOR-KATCH-7® and flocculant 180 is a polyacrylamide flocculant, such as K-FLOC®, KAN-FLOC®, OR KAT-FLOC®, all of which are manufactured by Kem-Tron, Inc. Moreover, neat polymers 170 may be “winterized” with additives, such as but not limited to ethylene glycol or polypropelene glycol, to lower their freezing point, for example, to −20° F.

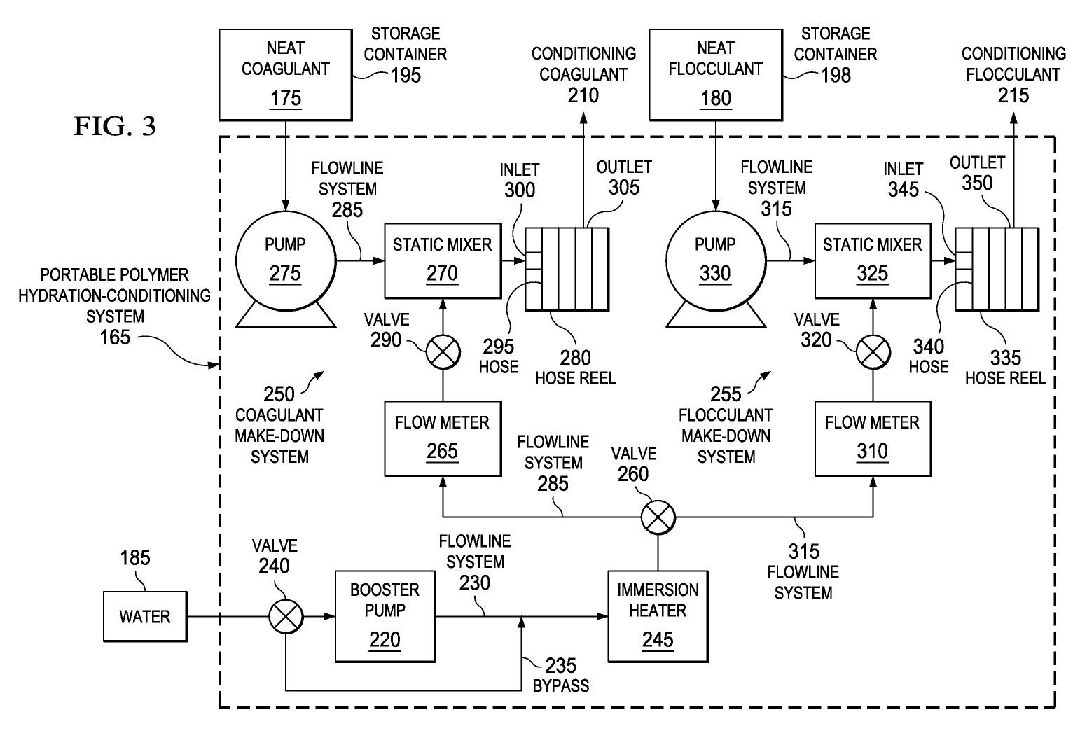

Turning now to FIG. 3, neat coagulant 175 and neat flocculant 180 are delivered from storage containers 195, 198, respectively, to portable polymer hydration-conditioning, or make-down, system 165. Water 185 is also delivered to make-down system 165 from a source external to make-down system 165, such as but not limited to a water storage tank or fire hydrant at a wellsite. As previously stated, make-down system 165 dissolves neat coagulant 175 and neat flocculant 180 with water 185 to produce working solutions of coagulant 175 and flocculant 180. Make-down system 165 subsequently enables sufficient residence time for the polymer working solutions to yield conditioning coagulant 210 and conditioning flocculant 215 for use in de-watering system 190 (FIG. 2).

Make-down system 165 includes a booster pump 220 coupled by a flowline system 230 to the source of water 185. If the pressure of water 185 is too low, for example, below 40 psig, for adequate make-up of neat coagulant 175 and neat flocculant 180, make-down system 165 is configured to deliver low pressure water 185 through flowline 230 to booster pump 220, where water 185 is pressurized to the proper level for make-up. In some embodiments, booster pump 220 is adjustable and operable to pressurize water 185 passing therethrough to within a range of 40 to 80 psig. In the event that water 185 has a pressure suitable for make-up at its source, make-down system 165 is further configured to bypass booster pump 220 via a branch 235 of flowline system 230. A valve 240 disposed in flowline system 230 upstream of booster pump 220 is operable to divert water 185 through booster pump 220 or through bypass branch 235 around booster pump 220, as needed. In some embodiments, booster pump 220 is further configured to shut down if the temperate or pressure of water 185 entering booster pump 220 is too high or low, respectively.

Downstream of booster pump 220, make-down system 165 further includes one or more immersion heaters 245 disposed along flowline system 230. Water 185 passing either from or around booster pump 220 is conveyed through immersion heater 245, where water 185 is heated to the proper temperature level for make-up. In some embodiments, immersion heater 245 is configured to increase the temperature of water 185 by at least 20° F. In preferred embodiments, immersion heater 245 increases the temperature of water 185 to at least 90° F. From immersion heater 245, pressurized, and now-heated water 185 is conveyed by flowline system 230 toward two parallel, and substantially identical, systems 250, 255 separated by a valve 260. Systems 250, 255 enable make-up of neat coagulant 175 and neat flocculant 180, respectively, using water 185. Valve 260 is operable to divert water 185 to either system 250, 255, as needed.

Coagulant make-down system 250 is coupled between storage tank 195 containing neat coagulant 175 and valve 260 at the terminal end of flowline system 230. Coagulant make-up system 250 includes a flow meter 265, a static mixer 270, a pump 275, and a hose reel 280 coupled by a flowline system 285. When water 185 is diverted from flowline system 230 into flowline system 285 by valve 260, water 185 initially passes through flowmeter 265, where measurements indicating the flow rate, temperature, and pressure of water 185 are collected. In some embodiments of portable polymer hydration-conditioning system 165, those measurements may be displayed and used by an operator to adjust at least one parameter of the coagulant conditioning process, for example, the flow rate of water 185.

After passing through flow meter 265, water 185 then passes into static mixer 270. In some embodiments, portable polymer hydration-conditioning system 165 further includes a check valve 290 disposed between flow meter 265 and static mixer 270. Check valve 290 is operable to prevent back flow of water 185 passing therethrough. At substantially the same time, neat coagulant 175 is delivered from storage container 195 into static mixer 270 by pump 275. In some embodiments, pump 275 is configured to be operable at variable speeds and thus can deliver neat coagulant 175 to static mixer 270 at a rate that can be adjusted as needed. Further, the speed of pump 275 may be displayed to enable such adjustment. Static mixer 270 is operable to mix neat coagulant 175 with water 185, or to hydrate neat coagulant 175.

To complete the make-down of neat coagulant 175, the hydrated coagulant or coagulant working solution is conveyed through flowline system 285 to hose reel 280. Hose reel 280 includes a length of flexible tubing or hose 295 having an inlet end 300 coupled to flowline system 285 and an outlet end 305 coupled to de-stabilizing zone 200 of de-stabilizing and flocculating manifold 120 (FIG. 2). The coagulant working solution flows from static mixer 270 through flowline system 285 along hose 295 to conditioning manifold 120. The length of hose 295 is selected to allow sufficient residence time within hose 295 to enable the hydrated coagulant to be uniform, thereby yielding conditioning coagulant 210 at outlet end 305 of hose 295. In some embodiments, hose 295 is approximately 50 feet in length and has ½ inch inner diameter.

Similarly, flocculant make-down system 255 is coupled between storage tank 198 containing neat flocculant 180 and valve 260 at the terminal end of flowline system 230. Flocculant make-up system 255 includes a flow meter 310, a static mixer 325, a pump 330, and a hose reel 335 coupled by a flowline system 315. When water 185 is diverted from flowline system 230 into flowline system 315 by valve 260, water 185 initially passes through flowmeter 310, where measurements indicating the flow rate, temperature, and pressure of water 185 are collected. In some embodiments of portable polymer hydration-conditioning system 165, those measurements may be displayed and used by an operator to adjust at least one parameter of the flocculant hydration or dissolution process, for example, the flow rate of water 185.

After passing through flow meter 310, water 185 then passes into static mixer 325. In some embodiments, portable polymer hydration-conditioning system 165 further includes a check valve 320 disposed between flow meter 310 and static mixer 325. Check valve 320 is operable to prevent back flow of water 185 passing therethrough. At substantially the same time, neat flocculant 180 is delivered from storage container 198 into static mixer 325 by pump 330. In some embodiments, pump 330 is configured to be operable at variable speeds and thus can deliver neat flocculant 180 to static mixer 325 at a rate that can be adjusted as needed. Further, the speed of pump 330 may be displayed to enable such adjustment. Static mixer 325 is operable to mix neat flocculant 180 with water 185, or to hydrate neat flocculant 180.

To complete the make-down of neat flocculant 180, the hydrated flocculant or flocculant working solution is conveyed through flowline system 315 to hose reel 335. Hose reel 335 includes a length of flexible tubing or hose 340 having an inlet end 345 coupled to flowline system 315 and an outlet end 350 coupled to aggregating zone 205 of de-stabilizing and flocculating manifold 120 (FIG. 2). The hydrated flocculant flows from static mixer 325 through flowline system 315 along hose 340 to manifold 120. The length of hose 340 is selected to allow sufficient residence time within hose 340 to enable the hydrated flocculant to uncoil or branch out, thereby yielding conditioning flocculant 215 at outlet end 350 of hose 340. In some embodiments, hose 340 is approximately 50 feet in length and has ½ inch inner diameter.

As described, portable polymer hydration-conditioning system 165 is configured to condition neat coagulant 175 and neat flocculant 180 for use in de-watering system 190. Moreover, portable polymer hydration-conditioning system 165 is operable to properly condition neat polymers 170 by the addition of pressure via booster pump 220 and heat via immersion heater 245, as needed, such that polymers 170 enable efficient de-watering of waste drilling fluid 135 with minimal waste of polymer material. Further, due to the introduction of pressure and heat, when needed, hydration time during conditioning of polymers 170 is reduced from that of conventional make-up systems, which are typically limited by the pressure and temperature of water obtained at the de-watering site.

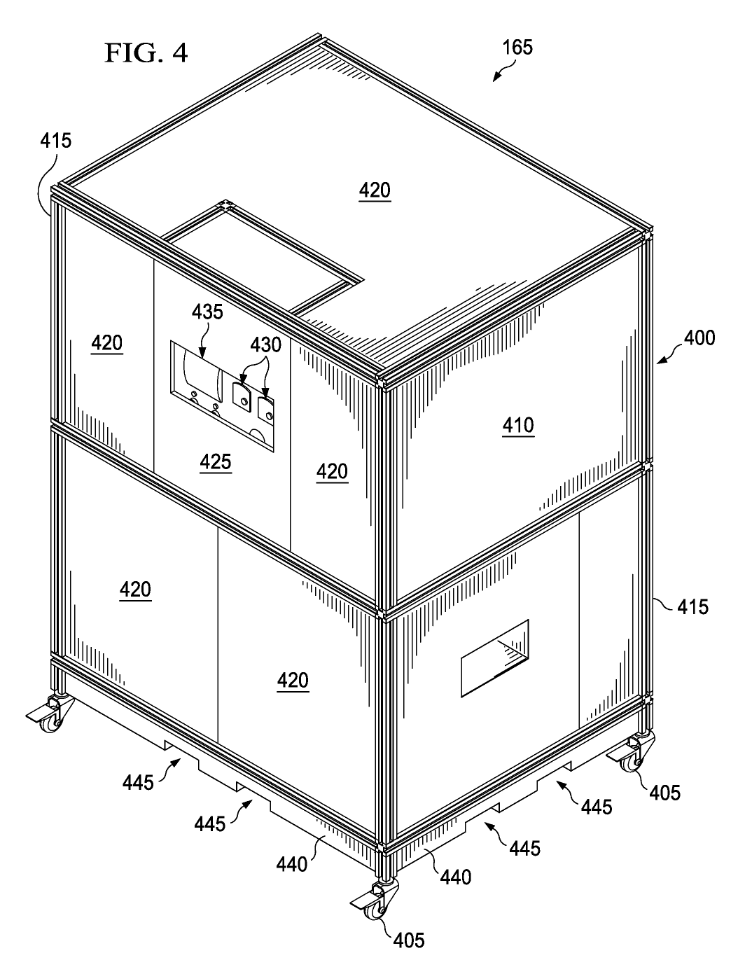

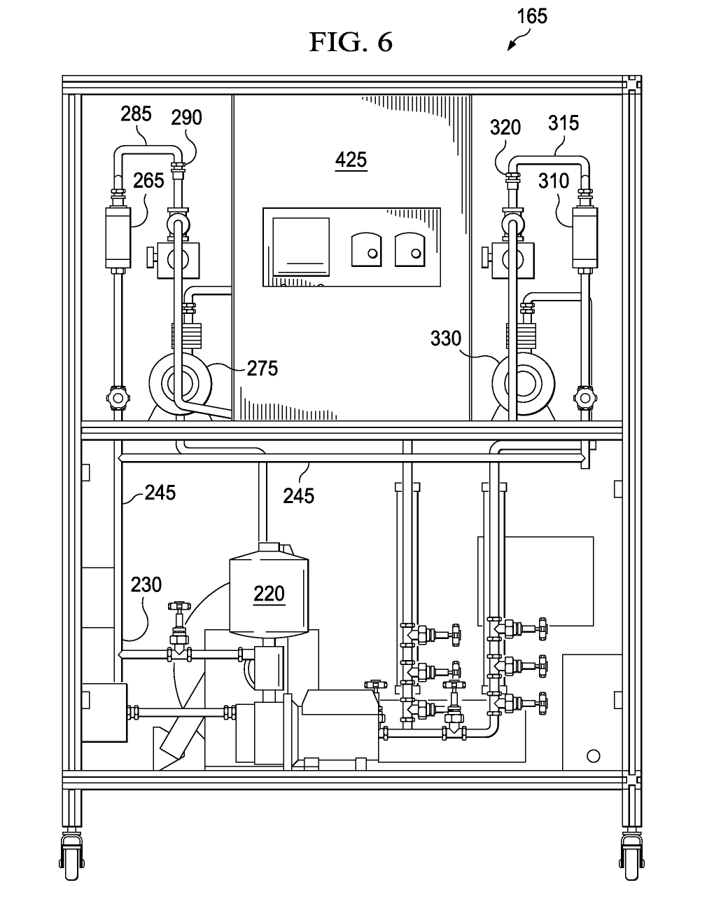

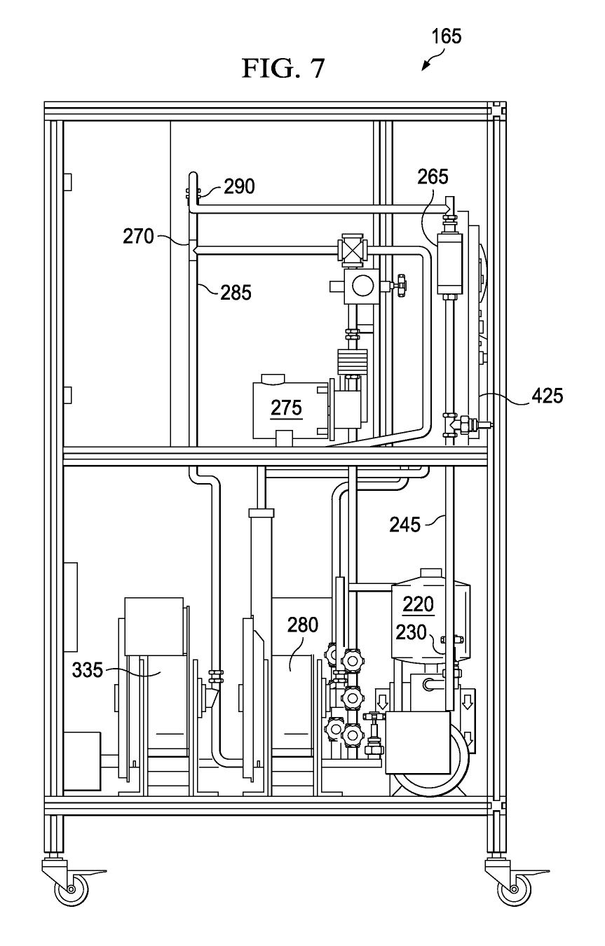

A physical embodiment of portable polymer hydration-conditioning system 165 is illustrated in FIGS. 4 through 7. Beginning with FIG. 4, portable polymer hydration-conditioning system 165 includes a six-sided housing 400 supported by four wheels 405. In some embodiments, wheels 405 are casters. Further, each caster 405 is removable to enable stowage of system 165 on its base. Housing 400 includes a skin 410 coupled to a frame 415. Skin 410 is formed by a plurality of panels or doors 420 that are removable, as needed, to access equipment disposed therein. In some embodiments, frame 415 and skin 410 are formed of aluminum and stainless steel, respectively. Further, in some embodiments, portable polymer hydration-conditioning system 165 has a 43 inch by 44 inch footprint, is 70 inches in height, and weighs less than 700 lbs.

Housing further includes four support panels 440 coupled to and extending from frame 415 proximate the base of housing 400. Each support panel 440 is configured to enable lifting of system 165. In some embodiments, each support panel 440 has a pair of recessed portions 445 configured to receive the forks on a forklift.

Portable polymer hydration-conditioning system 165 further includes a control panel 425 disposed between two or more access panels 420. Control panel 425 includes one or more controls 430 and one or more displays 435 that are accessible from the exterior of housing 400. In some embodiments, control panel 425 includes two controls 430 for adjusting the speed of coagulant pump 275 and flocculant pump 330, and a display 435 indicating a measurement of the total suspended solids (TSS) remaining within reclaimed colloidal-free water 155 (FIG. 1) exiting de-watering system 190. Depending on the value of TSS remaining in reclaimed colloidal-free water 155, adjustments may be made to any or all of coagulant pump 275, flocculant pump 330, booster pump 220, and immersion heater 245 to improve the clarity of reclaimed water 155.

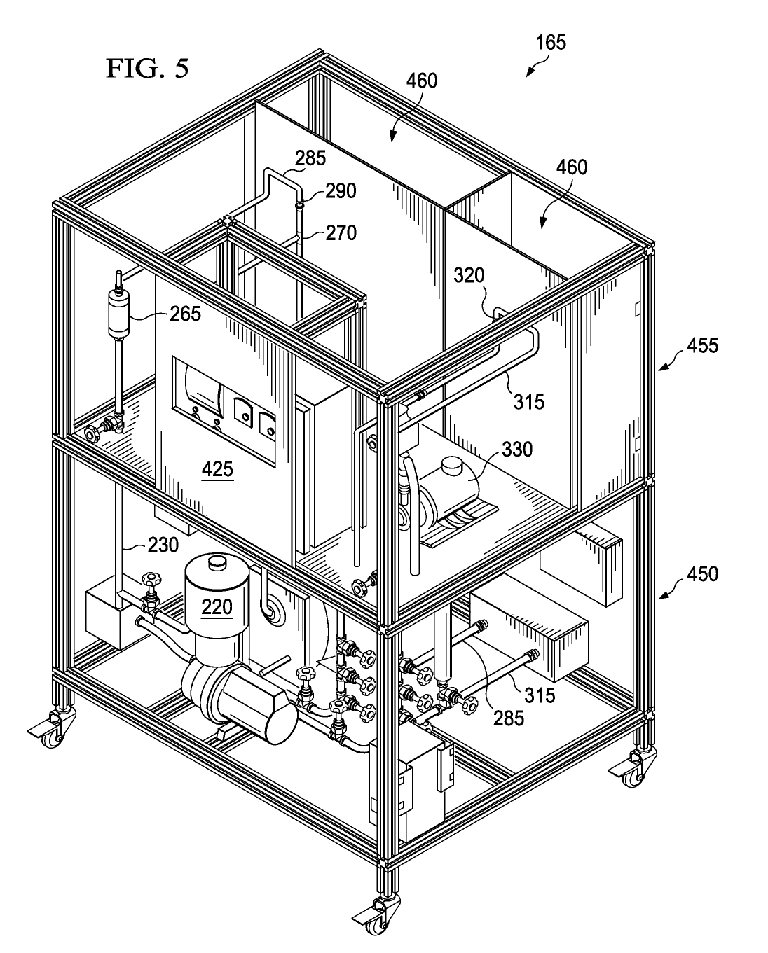

Turning now to FIGS. 5 through 7, portable polymer condition system 165 is shown with access panels 420 removed, exposing to view equipment disposed therein. As shown, housing 400 of system 165 is a bi-level structure, having a lower cabinet 450 and an upper cabinet 455. Hose reels 280, 335, booster pump 220, and immersion heater(s) 245 are disposed within lower cabinet 450. In some embodiments, portable polymer hydration-conditioning system 165 further includes insulation coupled to panels 420 of lower cabinet 450 and/or a heater within lower cabinet 450. Both serve to protect hoses 295, 340 and booster pump 220 in cold operating conditions. Additionally, in some embodiments, system 165 may further include piping configured to route incoming water 185 around electronic equipment, such as but not limited to control panel 425, for purposes of cooling such equipment in hot operating conditions.

Pumps 275, 330, static mixers 270, 325, flow meters 265, 310, and check valves 290, 320 are disposed within upper cabinet 455. In some embodiments, portable polymer hydration-conditioning system 165 further includes one or more storage bins 460 in upper cabinet 455 for storing extra hoses, fittings, and other equipment useful for operation of system 165.

The above-described embodiment is operable to make down both neat coagulant 175 and neat flocculant 180. In other embodiments, however, portable polymer hydration-conditioning system 165 may be operable to make down only a single polymer, either neat coagulant 175 or neat flocculant 180, depending upon which is required for a particular de-watering process. Such embodiments would include only coagulant make-down system 250 or flocculant make-down system 255, as appropriate.

While various preferred embodiments have been shown and described, modifications thereof can be made by one skilled in the art without departing from the spirit and teachings herein. The embodiments herein are exemplary only, and are not limiting. Many variations and modifications of the apparatus disclosed herein are possible and within the scope of the invention. Accordingly, the scope of protection is not limited by the description set out above, but is only limited by the claims which follow, that scope including all equivalents of the subject matter of the claims.

What is claimed is:

1. A system for conditioning a neat polymer with water, the system comprising:
a moveable housing supported by a plurality of wheels;
a pump operable to pressurize the water; and
an immersion heater operable to heat the water;
wherein the pump and immersion heater are disposed within the moveable housing.

2. The system of claim 1, further comprising a plurality of flowlines disposed within the moveable housing and coupling the pump and the immersion heater in series.

3. The system of claim 2, further comprising a polymer make-down system coupled to the plurality of flowlines and disposed within the moveable housing, the polymer make-down system configured to condition the neat polymer with the water.

4. The system of claim 3, wherein the polymer make-down system includes a static mixer, wherein the neat polymer and the water are mixed.

5. The system of claim 4, further comprising a hose in fluid communication with the static mixer, the hose having a length selected to enable adequate residence time for the hydrated polymer.

6. The system of claim 5, wherein the length of the hose is at least 20 feet in length.

7. The system of claim 3, wherein the neat polymer is one of a group consisting of a neat coagulant and a neat flocculant.

8. The system of claim 2, further comprising a second polymer make-down system coupled to the plurality of flowlines and disposed within the moveable housing, the second polymer make-down system configured to condition a second neat polymer with the water.

9. The system of claim 8, wherein the plurality of flowlines comprises a valve operable to divert the water to one of the polymer make-down systems.

10. A method for conditioning a neat polymer at a de-watering site, the method comprising:
coupling a water source at the de-watering site to a water pump disposed within a moveable housing;
coupling a container wherein the neat polymer is stored to a polymer pump disposed within the moveable housing;
pressurizing water from the water source with the water pump;
heating water from the water source with the immersion heater; and
hydrating the neat polymer with the heated, pressurized water from the water source in a static mixer disposed within the moveable housing.

11. The method of claim 10, further comprising conveying the neat polymer from a storage container external to the moveable housing to the static mixer with a polymer pump disposed within the moveable housing.

12. The method of claim 11, further comprising adjusting a speed of the polymer pump.

13. The method of claim 10, further comprising adjusting a pressure to which the water is pressurized in the water pump.

14. The method of claim 10, further comprising conveying the hydrated polymer through a hose coupled to a hose reel disposed within the moveable housing to a de-watering system.

15. A system for de-watering waste fluid comprising:
a moveable housing supported on wheels, the moveable housing comprising:
a water pump operable to pressurize water;
a heater operable to heat the water; and
a static mixer configured to hydrate a neat polymer with the pressurized, heated water; and
a conditioning manifold in fluid communication with the moveable housing, the conditioning manifold comprising at least one of:
a de-stabilizing zone adapted to combine a conditioned polymer and the waste fluid, wherein solids suspended in the waste fluid are de-stabilized, wherein a de-stabilized mixture is formed; and
an aggregating zone adapted to combine a conditioned flocculant and a de-stabilized mixture including the waste fluid and de-stabilized solid particles, wherein de-stabilized solids contained in the de-stabilized mixture are aggregated to form a plurality of flocs, wherein an aggregated mixture of the plurality of flocs and water is formed.

16. The system of claim 15, wherein the neat polymer is a neat coagulant and wherein the conditioning manifold comprises a de-stabilizing zone adapted to combine the conditioned coagulant and the waste fluid.

17. The system of claim 15, wherein the neat polymer is a neat flocculant and wherein the conditioning manifold comprises an aggregating zone adapted to combined the conditioned flocculant and the de-stabilized mixture.

18. The system of claim 15, further comprising a plurality of flowlines disposed within the moveable housing and fluidicly coupling the water pump, the heater, and the static mixer.

19. The system of claim 15, further comprising a polymer pump disposed within the moveable housing and operable to deliver the neat polymer to the static mixer at an adjustable rate.

20. The system of claim 15, further comprising a hose in fluid communication with the static mixer, the hose having a length selected to enable adequate residence time for the hydrated polymer.
